(19) United States
(12) Patent Application Publication
(10) Pub. No.: US 2024/0088350 A1
(43) Pub. Date: Mar. 14, 2024

(54) METHODS AND APPARATUS RELATING TO BIPOLAR BATTERIES

(71) Applicant: THE ULTIMATE BATTERY COMPANY LTD, Hyde, Cheshire (GB)

(72) Inventors: Maurizio CUNNINGHAM-BROWN, Hyde, Cheshire (GB); Keith Gordon ELLIS, Hyde, Cheshire (GB); Malcolm EARP, Hyde, Cheshire (GB)

(21) Appl. No.: 18/274,384

(22) PCT Filed: Jan. 24, 2022
(86) PCT No.: PCT/GB2022/050177

§ 371 Date: Jul. 26, 2023

(30) Foreign Application Priority Data
Jan. 26, 2021 (GB) 2101020.2

(51) Int. Cl. H01M 4/21; H01M 4/04; H01M 4/14; H01M 4/66; H01M 10/18

(52) U.S. Cl. CPC H01M 4/21; H01M 4/0433; H01M 4/14; H01M 4/667; H01M 4/668; H01M 10/18; H01M 2004/029

(57) ABSTRACT

A method of manufacturing a plate suitable for use as a bipolar plate 500 in a bipolar battery 1 is disclosed. The method comprises the steps of extruding a first polymer containing conductive particles to form a conductive polymer plate 505, cutting a conductive polymer core 512 from the conductive polymer plate 505, and overmoulding the conductive polymer core 512 with a second polymer to provide a non-conductive polymer surround 516. A bipolar battery 1 is also disclosed, as well as a method of making a bipolar battery 1.

### BACKGROUND

The present invention concerns batteries. More particularly, but not exclusively, the present invention concerns bipolar batteries, apparatus for forming bipolar batteries, and associated methods of manufacturing.

Bipolar batteries are known in the prior art, see Tatematsu US 2009/0042099, incorporated herein by reference in its entirety. Bipolar battery architecture provides a more compact energy storage arrangement with a sandwich of conductive plates providing anode and cathode in one plate and active material between. This technology has been in existence since 1924 but has suffered from several problems including the sealing of the cells to prevent electrolyte solution leakage. Traditionally the understanding from prior art is that sealing of bipolar cells has been achieved using a gasket, but these have proven to be unreliable, leading to electrolyte leakage and eventual cell failure.

Subsequent bipolar batteries have utilised plastic, silica or ceramic composite plates with holes and metal vias to conduct the charge from the cathode to the anode side of the plate. In the example of Lead chemistry with non-conductive plastic the prior art process of melting solder through the holes (vias) to an acceptable level of conductive consistency has been achieved through using thin plates resulting in flexing of the plates from gas emissions produced during charging and fracturing around the vias during charge and discharge process leading to individual cell and eventual battery failure. Another problem encountered has been the excessive dendrite formation in the proximity of the vias leading to battery charge capacity degradation.

WO2016178703 discloses a bipolar plate made from a polymer core including conductive fibres. The disclosure provides inadequate teaching on how to mass produce commercially useable batteries, however.

The present invention seeks to mitigate one or more of the above-mentioned problems. Alternatively or additionally, the present invention seeks to provide improved methods for manufacturing bipolar batteries, improved apparatus for forming bipolar batteries, and/or improved bipolar batteries.

### SUMMARY OF THE INVENTION

The present invention provides, according to a first aspect, a method of manufacturing a plate suitable for use as a bipolar plate in a bipolar battery. The method comprises a step of extruding a first polymer containing conductive particles to form a conductive polymer plate. The method includes a step of then cutting a conductive polymer core for the bipolar plate from the conductive polymer plate. The method includes overmoulding a conductive polymer core, for example a conductive polymer core that has been formed by such an extrusion and cutting process, with a second polymer to provide the conductive polymer core with a non-conductive polymer surround. In embodiments, the thickness of the non-conductive polymer surround is greater than the thickness of the conductive polymer core.

It has been discovered that extrusion provides a particularly advantageous method for producing conductive polymer cores for bipolar plates because a relatively uniform distribution of conductive particles (such as tin coated carbon fibres) is achieved in the resulting conductive polymer cores. In moulding processes where the polymer flows (for example in injection moulding or hot-pressing), the conductive particles can lag behind the molten polymer front, which can result in the conductive polymer cores having areas with a relatively low density of conductive particles. This can adversely affect the conductivity of a bipolar plate.

The conductive polymer plate may define a plane, and the thickness direction may be substantially perpendicular to that plane. The non-conductive polymer surround may extend from the plane defined by the conductive polymer plate in one direction. Alternatively, the non-conductive polymer surround may extend from the plane defined by the conductive polymer plate in two, opposite directions.

The skilled person will be aware of a number of techniques for cutting a conductive polymer core from the conductive polymer plate, and it should be understood that the invention is not limited to the use of any particular cutting method.

The first polymer and the second polymer may be the same polymer. Alternatively, the first polymer and the second polymer may be different polymers.

The method may comprise the step of abrading at least one of the surfaces of the conductive polymer plate to expose the conductive particles prior to the step of cutting the conductive polymer core for the bipolar plate from the conductive polymer plate. Both of the surfaces of the conductive polymer plate may be abraded to expose conductive particles. The surfaces may be abraded simultaneously. The step of abrading removes an outer surface layer of polymer to ensure that conductive particles are exposed on the surface. The step of abrading may comprise surface abrasion, chemical etching, laser etching, treatment by gas plasma or other surface removal method.

The step of abrading may comprise abrading the at least one surface of the conductive polymer plate as the conductive polymer plate leaves the extruder. The step of abrading may therefore take place in a continuous production line that is being fed by the conductive polymer plate leaving the extruder.

Both surfaces of the conductive polymer plate may be abraded simultaneously. For example, both surfaces of the conductive polymer plate may be laser etched simultaneously. The process of laser etching may comprise etching up to a maximum depth of 100 μm. The laser etching may comprise etching up to a maximum depth of 50 μm. The laser etching may comprise etching up to a maximum depth of 20 μm. The laser etching may comprise etching up to a maximum depth of 10 μm.

The conductive polymer core may cooled to room temperature before the step of overmoulding. Room temperature should be understood to be a temperature of less than approximately 30 degrees centigrade. Cooling the conductive polymer core to room temperature may help prevent warping of the polymer core during or after the step of overmoulding.

The cross-section of the extruded conductive polymer core may comprise one or more sections of different thickness, for example the conductive polymer core may comprise one or more ribs. The cross-section of the extruded conductive polymer core may comprise one or more sections of different height—for example different amounts of separation from a notional plane parallel to the plate—for example the conductive polymer core comprising one or more corrugations. Thus, the extruded conductive polymer plate may be ribbed or corrugated. The conductive polymer core of the plate may therefore be ribbed or corrugated. Corrugations increase the surface area of the conductive polymer core, relative to a flat core of the same dimensions, which may provide enhanced electrical properties to the bipolar battery. Furthermore, the corrugated plate will be stiffer than a flat plate having the same planar dimensions and thickness. Therefore corrugated plates may contribute to the structural stiffness of the bipolar battery in which the bipolar plate is used. This may allow for reduction in the size/mass of other parts of the battery/bipolar plate. For example, increasing the stiffness of the conductive polymer core may allow for a reduction in the size of the non-conductive polymer surround. As a result of the extrusion process the conductive polymer core may have a substantially constant cross-section, at least in part.

The method may comprise the step of providing a first metallic layer of a first thickness on a first side of conductive polymer core and providing a second metallic layer of a second, greater thickness on a second side of the conductive polymer core. The first and/or second metallic layers may be provided on the conductive polymer plate prior to the step of cutting the conductive polymer core from the conductive polymer plate. Alternatively, the first and/or second layers may be provided on the conductive polymer core after the step of overmoulding. The first layer may have a thickness of up to 100 μm. The second layer may have a thickness of up to 300 μm. In some embodiments, the first layer may have a thickness of up to 50 μm and the second layer may have a thickness of up to 200 μm. In some embodiments, the first layer may have a thickness of approximately 30 μm and the second layer may have a thickness of approximately 150 μm.

At least part of the first metallic layer or at least part of the second metallic layer may be formed by electroplating onto the surface of the conductive polymer plate. Electroplating has been found to provide a metallic layer with good adhesion to the surface of the conductive polymer plate. At least part of the first metallic layer or at least part of the second metallic layer may be formed by cold spraying. Cold spraying may provide a cheaper and quicker method of providing a metallic layer than via electroplating.

For either of the metallic layers, part or all of the layer may be cold sprayed directly only the surface of the conductive polymer plate. Alternatively, for either of the metallic layers, part of the metallic layer may be formed by electroplating onto the surface of the conductive polymer plate and another part of the metallic layer may be formed by cold spraying onto the electroplated part of the layer. Therefore electroplating may be used to provide a base part of the metallic layer with good adhesion to the conductive polymer plate

A first part of the second metallic layer may be formed by electroplating onto the surface of the conductive polymer plate and a second part of the second metallic layer may be formed by cold spraying onto the electroplated first part. Optionally, at least part of the first metallic layer is formed by electroplating onto the surface of the conductive polymer plate, and the at least first part of the first metallic layer has a thickness that is equal to the thickness of the first part of the second metallic layer.

The present invention provides, according to a second aspect, a method of manufacturing plate suitable for use as a bipolar plate for a bipolar battery. The method comprises a step of cold spraying at least one side of a conductive polymer plate (suitable for forming a conductive polymer core of a bipolar plate) to provide a metallic layer on the at least one side of conductive polymer plate. Cold spraying has been found to provide a particularly efficient way of providing a metallic layer for forming the cathode and/or anode of a bipolar plate.

The method may comprise the step of providing a first metallic layer of a first thickness on a first side of conductive polymer plate and providing a second metallic layer of a second, greater thickness on a second side of the conductive polymer plate. The first and/or second metallic layers may be provided on the conductive polymer plate prior the plate being cut into conductive polymer cores for forming the plates. Alternatively, the first and/or second metallic layers may be provided on the conductive polymer plate when it is in the form of a conductive polymer plate having a non-conductive polymer surround. The first layer may have a thickness of up to 100 μm. The second layer may have a thickness of up to 300 μm. In some embodiments, the first layer may have a thickness of up to 50 μm and the second layer may have a thickness of up to 200 μm. In some embodiments, the first layer may have a thickness of approximately 30 μm and the second layer may have a thickness of approximately 150 μm.

The thickness of the metallic layers may be within a range of 20 μm to 500 μm and in the example of lead in the range 30 μm to 70 μm on the anode (negative) side of the plate and 120 to 200 μm on the cathode (positive) side of the plate. The first metallic layer on the first side of the plate may form an anode. The second metallic layer on the second side of the plate may form the cathode.

At least part of the first metallic layer or at least part of the second metallic layer may be formed by electroplating onto the surface of the conductive polymer plate. Electroplating has been found to provide a metallic layer with good adhesion to the surface of the non-conductive polymer plate. At least part of the first metallic layer or at least part of the second metallic layer may be formed by cold spraying. Cold spraying may provide a cheaper and quicker method of providing a metallic layer than via electroplating.

For either of the metallic layers, part or all of the layer may be cold sprayed directly only the surface of the conductive polymer plate. Alternatively, for either of the metallic layers, part of the metallic layer may be formed by electroplating onto the surface of the conductive polymer plate and another part of the metallic layer may be formed by cold spraying onto the electroplated part of the layer. Therefore electroplating may be used to provide a base part of the metallic layer with good adhesion to the conductive polymer plate

A first part of the second metallic layer may be formed by electroplating onto the surface of the conductive polymer plate and a second part of the second metallic layer may be formed by cold spraying onto the electroplated first part. Optionally, at least part of the first metallic layer is formed by electroplating onto the surface of the conductive polymer plate, and the at least first part of the first metallic layer has a thickness that is equal to the thickness of the first part of the second metallic layer.

The metallic layers may include an alloy and in the example of Lead chemistry this may include an alloy of Lead and Tin. The percentage of tin in the alloy may be in the range of 1% to 10% or ideally 2% to 4%.

The metallisation may be preceded by a precursor metal coating which in the example of Lead could be Tin or another compatible metal or alloy with a surface coating in the range 1 micron to 20 microns, but ideally 2 microns to 5 microns.

Metallisation by electro-deposition may include the rotation of the conductive plate in electrolyte to reduce the plating period, and may include a mixture of plating techniques carried out in series including cold spraying, vapour deposition of foil lasering.

The present invention provides, according to a third aspect, a method of manufacturing plate suitable for use as a bipolar plate for a bipolar battery. The method comprises a step of laser etching at least one face of a conductive polymer plate, the plate being suitable for forming a conductive polymer core of a bipolar plate of the bipolar battery. The laser etching may cause abrading of the surface of the conductive polymer plate for example sufficient to expose the conductive particles of the conductive polymer plate. Other means of abrading may be suitable, but embodiments employing the precise abrading made possible by laser etching have been found to be particularly advantageous.

The process of laser etching may comprise etching up to a maximum depth of 100 μm. The laser etching may comprise etching up to a maximum depth of 50 μm. The laser etching may comprise etching up to a maximum depth of 20 μm. The laser etching may comprise etching up to a maximum depth of 10 μm. Both of the surfaces of the conductive polymer plate may be abraded to expose conductive particles. The surfaces may be abraded simultaneously. Both surfaces of the conductive polymer plate may be laser etched simultaneously. The step of abrading removes an outer surface layer of polymer to ensure that conductive particles are exposed on the surface.

The step of abrading may comprise abrading the at least one surface of the conductive polymer plate as the conductive polymer plate leaves an extruder. Alternatively, the step of abrading my take place when the conductive polymer plate already forms part of a plate comprising a non-conductive surround.

According to a fourth aspect, the present invention provides a method of manufacturing a bipolar battery. The method comprises a step of manufacturing a plurality of plates, for example using the method of any of the first, second, or third aspects of the invention. The method comprises a step of forming a stack of the plurality of plates and sandwiching the plates between two monopolar plates. There may be a step of placing electrolyte material into a dish formed by first bipolar plate, the dish comprising a base provided by a metallic layer of the first bipolar plate and sides defined by the non-conductive surround of the first bipolar plate. There may be a step of engaging the non-conductive surround of a first bipolar plate with the non-conductive surround of a second bipolar plate such that a metallic layer of the second bipolar plate and the dish of the first bipolar plate define a chamber which contains the electrolyte material. The electrolyte material may thus be positioned between an anode layer of one of the first and second plates and an opposing cathode layer of the other of the first and second plates. The bipolar battery so made may have bipolar plates which each comprise a conductive polymer core having a substantially constant cross-section, at least in part. The bipolar battery so made may have bipolar plates which each comprise a conductive polymer core integrally formed with a non-conductive polymer surround (e.g. moulded together).

According to a fifth aspect, the present invention provides, a bipolar battery comprising a stack of multiple bipolar plates sandwiched between two monopolar plates. The bipolar plates each comprise a conductive polymer core and a non-conductive polymer surround. There is a layer of anode material on one side of the bipolar plate and a layer of cathode material on the opposite side of the bipolar plate. The battery comprises a casing, the layers of anode material and cathode material being contained within the casing. It is preferred that the casing is formed at least in part by the non-conductive polymer surrounds of all of the bipolar plates. The bipolar battery may have been manufactured using any of the methods of any of the first, second, third, or fourth aspects of the invention.

The bipolar plates may comprise an extruded conductive polymer core having a substantially constant cross-section. The core may be moulded to the non-conductive polymer surround. The constant cross-section of the extruded conductive polymer core comprises one or more sections of different thickness, for example comprising one or more ribs. The constant cross-section of the extruded conductive polymer core comprises one or more sections of different height, for example comprising one or more corrugations.

The non-conductive polymer surround of each bipolar plate may be directly connected to, and preferably sealed with, the non-conductive polymer surround of an adjacent bipolar plate. It is preferred for there to be no intervening structure.

It may be that the surround of each bipolar plate is connected to, and sealed with, the non-conductive polymer surround of an adjacent bipolar plate via a tongue and groove arrangement.

It may be that in the region of the sealed connection between the surround of each bipolar plate and the adjacent bipolar plate there is disposed a conductive wire, for example able to provide sufficient heat energy when a current is passed via the wire to melt the polymer material in the region of the sealed connection. The wire may be a metallic wire. The wire may be a conductive polymer track. The wire may be moulded or inserted into the surface of the non-conductive polymer surround. Such an arrangement provides the ability to weld adjacent bipolar plates together. The conductive wire can also be used at the end of life of the battery to melt the plate joints and disassemble the battery cells.

The non-conductive polymer surround may extend from the conductive polymer core further on one side than the other, such that on one side a first recess is defined for accommodating electrolyte material of the battery. The conductive polymer core and non-conductive polymer surround may define a second recess on the opposite side of the bipolar plate to the first recess, the first recess being deeper than the second recess. The layer of cathode material may form at least part of the base of the first recess. The layer of anode material may form at least part of the base of the second recess. The bipolar plate holding the electrolyte may comprise the cathode layer of a cell of the battery and the anode layer of that cell may be formed by an adjacent bipolar plate. In the illustrated embodiments, the number of battery cells that form the battery is equal to the number of bipolar plates plus one, each bipolar plate forming the boundary of one cell on one side of the plate and a second cell on the other side of the plate.

It may be that the depth of the recess formed by the surround and the conductive polymer core is at least 20% more on one side than the corresponding depth on the other side. In embodiments of the invention such an arrangement is particularly advantageous for facilitating manufacture of the bipolar battery because the deeper recess provides a dish into which electrolyte material of the battery, which may be frozen, can be placed during manufacture of the bipolar battery. This arrangement also enables the bipolar battery to better accommodate the pressure changes experienced by the cell during charging and discharging.

The bipolar battery may further comprise electrolyte material held between an anode layer and an opposing cathode layer. Electrolyte material may be held at least in part by a porous matrix structure. The matrix structure may be a honeycomb structure. The honeycomb structure may be made from a rigid polymer material to provide structural support, for example made from ABS, PPS or any other suitable polymer. There be more one or more absorptive glass mats for containing electrolyte material. Electrolyte material may be sandwiched between absorptive glass mats for example. Such absorptive glass mats may be located adjacent to a porous matrix structure, such as the honeycomb structure mentioned above. The porous matrix structure (e.g. honeycomb structure) may be sandwiched between absorptive glass mats for example.

It may be that a gas exhaust is provided as part of the non-conductive polymer surround of each bipolar plate. The gas exhaust may comprise a conduit. The gas exhaust, or for example a conduit of the gas exhaust, may be configured to restrict flow of electrolyte out of the gas exhaust/conduit. The gas exhaust may comprise a pressure relief valve. The gas exhaust may comprise a gas permeable membrane, for example a polymer membrane. It may be that a pressure relief valve is provided as part of the nonconductive polymer surround of each bipolar plate. The gas exhausts of all the surrounds may vent into a common plenum chamber. The pressure relief valves of all the surrounds may vent into a common plenum chamber. The common plenum chamber may have a pressure relief valve that vents to atmosphere. The common plenum chamber may have fewer pressure relief valves than the number of cells that are arranged to exhaust gas into the plenum chamber. The common plenum chamber may be arranged to limit the differences in pressure sustained by the battery cells that are arranged to exhaust gas into the plenum chamber.

According to a sixth aspect, the present invention provides, a bipolar battery comprising a stack of multiple bipolar plates sandwiched between two monopolar plates. The bipolar plates each comprise an extruded conductive polymer core thus having a substantially constant cross-section. The core is moulded to a non-conductive polymer surround. There is a layer of anode material on one side of the bipolar plate and a layer of cathode material on the opposite side of the bipolar plate. The battery comprises a casing and the layers of anode material and cathode material are contained within the casing. The casing is formed at least in part by the non-conductive polymer surrounds of all of the bipolar plates.

Optionally, the constant cross-section of the extruded conductive polymer core comprises one or more sections of different thickness, for example comprising one or more ribs. The constant cross-section of the extruded conductive polymer core may comprise one or more sections of different height, for example comprising one or more corrugations. Additionally, the bipolar battery of the sixth aspect of the invention may comprise any of the features described with respect to the bipolar battery of the fifth aspect of the invention.

The present invention provides, according to a seventh aspect, a method of manufacturing a bipolar battery. The bipolar battery may be one according to the fifth aspect of the invention. The method may comprise a step of forming a stack of multiple bipolar plates sandwiched between two monopolar plates. Each bipolar plate may comprise a conductive polymer core having a non-conductive polymer surround. Each bipolar plate may comprise a layer of anode material on one side of the plate and a layer of cathode material on the opposite side of the plate. The method may be so performed that when forming the stack of plates, the non-conductive polymer surround of each bipolar plate is in direct contact with the non-conductive polymer surround of an adjacent plate. There may be a step of melting the polymer material local to the area of contact between the non-conductive polymer surrounds to form a sealed joint between adjacent bipolar plates, for example by causing current to flow along a wire embedded in the region of the area of contact, which generates heat sufficient to melt the polymer material. The method may comprise any of the steps of the methods of any of the first, second, third, or fourth aspects of the invention.

Each bipolar plate may be so shaped as to form a dish for accommodating electrolyte material. The stack of bipolar plates may be formed by placing an electrolyte material into the dish of a first bipolar plate. The stack may be formed by engaging the first bipolar plate with a second bipolar plate such that a surface of the second bipolar plate and the dish of the first bipolar plate define a chamber which contains the electrolyte material, the electrolyte material thereby being positioned between an anode layer of one of the first and second plates and an opposing cathode layer of the other of the first and second plates. Electrolyte material may then be placed into the dish provided by the second bipolar plate. Further bipolar plates may be added and/or the stack may be capped with a monopolar plate. The method may comprise an earlier step of placing electrolyte material into the dish of a monopolar plate, and engaging the monopolar plate with the first bipolar plate so as to define a chamber containing the electrolyte material. One of the monopolar plates may have a recess that acts as a dish for containing the electrolyte material, whereas the other monopolar plate may have no such recess or a shallower recess. The chamber of each cell that is so formed and which contains the electrolyte material may be a closed chamber that is subsequently sealed, for example using a technique such as that described below.

It may be that the non-conductive polymer surround of each bipolar plate includes a shaped formation around its perimeter of a first type on one side of the plate and a second type on the other side. The shaped formations may have a mutually corresponding shape such that the formation of the first type of a first bipolar plate fits against the formation of the second type of a second bipolar plate such that when fitted together the plates are correct aligned in a position ready for forming the sealed joint therebetween. The formation of the first type may include a protruding part that is accommodated within a recess of the formation of the second type. The heat generating wire mentioned above may be embedded in the protruding part of the formation. The heat generating wire mentioned above may be embedded in the recess of the formation of the second type.

The method may include a step of adding a layer of frozen electrolyte material between a layer of anode material on a bipolar plate and a layer of cathode material on an adjacent bipolar plate, before the step of melting the polymer material to form the sealed joint between the adjacent bipolar plates. The thickness of the frozen electrolyte layer may be greater than the depth of the dish such that the frozen electrolyte protrudes from the dish. The frozen electrolyte may be compressed during the step of engaging the first bipolar plate with the second bipolar plate. There may be a step of actively heating the frozen electrolyte material.

The method may include a step of co-moulding the conductive polymer core and the non-conductive polymer surround of each bipolar plates in advance of forming the stack such that the conductive polymer core and non-conductive polymer surround are integrally formed. Such a step may be performed by a different party, and optionally at a different locations, as compared to the steps of sealingly joining the stack of plates together. This invention may thus provide a method of making a plate comprising a conductive polymer core and an integrally formed non-conductive polymer surround independently of making a battery. The step of co-moulding may include embedding a resistive wire, for example a conductive polymer track, into the surface of the non-conductive polymer surround (or otherwise on or into the surround). The step of co-moulding may include embedding a pressure relief valve in the non-conductive polymer surround.

The method may include a step of laser welding conductive material to the surface of the conductive polymer core. There may then be a step of adding active material, for example cathode material, to the conductive material on the surface.

There may be a step of making the conductive polymer core of each bipolar plate in advance of forming the stack. Such a step may include creating one or more conductive structures using an additive manufacturing process, adding polymer material and then curing and/or hardening the polymer to embed, at least partially, the one or more conductive structures within the polymer material. The additive manufacturing process may include adding active (anode and/or cathode) material to the one or more conductive structures.

The present invention provides, according to a further aspect, a plate comprising a conductive polymer core and an non-conductive polymer surround suitable for use in forming a bipolar plate of the battery of the present invention and/or formed by any of the methods of the first, second, or third aspects of the invention. Such a plate may optionally comprise a layer of anode material on one side of the plate and a layer of cathode material on the opposite side of the plate.

It will of course be appreciated that features described in relation to one aspect of the present invention may be incorporated into other aspects of the present invention. For example, the methods of the invention may incorporate any of the features described with reference to the apparatus of the invention and vice versa.

### BRIEF DESCRIPTION OF THE DRAWINGS

Embodiments of the present invention will now be described by way of example only with reference to the accompanying schematic drawings of which:

FIG. 1 shows a metallized plate shown during an assembly/manufacturing process for forming a battery in accordance with an embodiment of the invention;

FIG. 2 shows the plate of FIG. 1 at a later stage of the assembly/manufacturing process;

FIG. 3 is an ‘exploded’ cross section of the cell stack arrangement of conductive polymer bipolar plates of a battery according to the embodiment;

FIG. 4 is a ‘magnified and exploded’ part of FIG. 3;

FIG. 5 is a cross section of a structure for holding the electrolyte of the battery;

FIG. 6 is a schematic cross section of a portion of a battery according to an embodiment of the invention,

FIG. 7 is a schematic drawing illustrating a method of manufacturing a plate in accordance with another embodiment of the invention,

FIG. 8 is a drawing of a corrugated extruded conductive polymer core, and

FIG. 9 is a schematic drawing illustrating a metallization process in accordance with another embodiment of the invention.

### DETAILED DESCRIPTION

Embodiments of the invention relate to a bipolar battery comprising a stack of bipolar battery plates sandwiched between two monopolar plates. While the invention is referred herein to as a bipolar “battery”, it will be understood by the skilled person that such arrangements may also be known in the art as a bipolar accumulator, or bipolar power unit.

The bipolar battery plates are constructed using acrylonitrile butadiene styrene (ABS) polymer or similar electrolyte resistant thermoplastic polymer suitable for alternative chemistries and filler based on a conductive element. Other chemistries such as Lithium, Nickel metal hydride, Sodium, may require thermoplastics with differing melting point characteristics to allow for the range of charge and discharge temperatures within the cells. The polymer plates are engineered to be conductive and comprise filler material, which may assist in providing such conductivity. The filler may, for example, comprise filaments, fibre, particulates and other fillers and additives. The filler may provide additional functions, for example for purposes such as assisting with injection moulding and/or enhancing mechanical strength. Such agents will typically be required to have a composition compatible with the battery chemistry. In the example of Lead chemistry, the polymer plates may be made with polymer having a filler comprising carbon fibres coated with Nickel, Tin, Aluminium, Gold or any other primary metal or alloy of metals. The conductive part of each polymer plate is enclosed by a substantially thicker non-conductive polymer surround.

A two-shot moulding process is used to create the conductive thermoplastic polymer plate and the non-conductive surround. More specifically, the conductive polymer plate is co-moulded, and thus integrally formed with, its non-conductive surround by means of an injection moulding process which dispenses the conductive and non-conductive polymers during the same cycle, the two polymers hardening in parallel. The surround is designed with a tongue and groove so that during primary assembly the completed cells can only be connected together in the correct alignment, providing a first level of sealing, by mechanical interlocking prior to final joining and sealing of the plastic surrounds by a technique such as resistive implant welding, fusion welding, pulse fusion welding or other process to seal the cell surround perimeter.

The construction of the bipolar plates may alternatively be constructed by the 3-D printing (i.e. an additive manufacturing process) of a conductive filament and the subsequent flooding of the said filament with molten thermoplastic polymer in a mould to ensure accurate dimensions and proximity of the filament to effect correct plate conductivity, and to which will be attached the surround made of similar thermoplastic polymer to the correct dimensions and alignment.

The manufacture of the bipolar cells forms a part of an automated assembly method which seeks to prevent leakage of electrolyte during the process. The plates are made of sufficient thickness to reduce the plate flexing due to increased internal cell pressure from generation of gasses or vapours during charging. In the example of Lead chemistry this is mitigated by addition of a suitable valve system to control internal cell pressure; for example limited to no more than 10 psi, preferably 0.5-8 psi, or more preferably 1-4 psi. One such suitable valve is a Bunsen valve. Each individual cell may be equipped with a valve or each cell may be in communication with one another via a common chamber to equalize cell gas pressures with a single external valve to prevent over pressure of the battery. Typical plate thickness will be in the range 0.2 mm to 20 mm depending on the energy requirement of the battery.

The conductive polymer plates with the non-conductive surround are provided with a metalized layer. The metalized layer may be provided by a metal foil, cold spraying, or electrostatic deposition which is welded or applied by electroplating or impact deposition consistently across the entire conductive plate surface forming a strong electrical connection with the conductive element within the bipolar plate and forms the connectivity path through the plate. In some embodiments, the non-conductive surround is not subject to metallization.

Active materials are applied to the metallized surfaces of the plates to provide anode material (e.g. lead) on one side of the plate and cathode material (e.g. lead dioxide) on the opposite side. The process of applying active materials to the plates can be performed at the same time as the metallization of the plates. For example, the active material may be applied to a metal foil, or other metallised surface, that is then applied to the plates (so that the metallisation and application of active material happens simultaneously). Metallization of the plates can also include plasma deposition, chemical vapour deposition, laser welding and other metallization techniques. The application of the active material includes electro-chemical deposition, 3D printed deposition, application as a semi-solid paste with curing and other applications. In the example of lead chemistry, the active material would include lead for the anode and lead dioxide deposited as an aqueous paste on the cathode faces of the plate.

To provide extra plate surface area the metal surface of the plate may be foamed to provide greater area of contact with the electrolyte. The foaming includes 3D printing of the foam, cold spraying or electrostatic deposition. In the example of Lead chemistry foaming or 3D printing of the lead is applied to the process to greatly increase the surface of contacts between the electrolyte and active material. Such foaming can be applied to the bipolar plate to increase the active surface and thereby the energy density—preferably the foam porosity should be greater than 50%.

Additional material may be applied to enhance the energy and power density for example, adding carbon nanotubes as an example suitable for use in lead chemistry. Such material may for example be embedded in the conductive polymer plate. Such additional material may alternatively/additionally include graphene, carbon, graphite, titanium dioxide, titanate materials and vinylene carbonate, which may for example be better suited to other chemistries. The application of these additives may be through, mixing with the active material, rollering or spraying.

The electrolyte used in this example of lead chemistry is diluted H₂SO₄ which is contained in an absorptive glass mat (AGM) and ABS honeycomb sandwich. The ABS honeycomb structure may be manufactured by 3D printing or additive manufacturing process. For other chemistries the electrolyte will use other absorptive material with the same mechanical properties which are impervious to electrolyte erosion dependent on the chemistry. Examples for electrolyte and solvent for lithium batteries include lithium hexafluorophosphate (LiPF 6), lithium bis(bistrifluoromethanesulphonyl) imide (LiTF SI), organoborates, phosphates and aluminates in a stable solvent including linear and cyclic carbonates and polymer gels. The structure provided for containing the electrolyte, for example in an absorptive manner, should provide sufficient flexibility to allow active material expansion during the discharge process but with sufficient rigidity (for example provided by a ABS honeycomb) to limit the extent of plate flexing from the valve controlled internal cell gas or vapour pressure created during the charging process. In the example of lead chemistry, the electrolyte in its AGM/ABS honeycomb repository is positioned in between the active material coated cathode and anode plates which form the boundary of a cell, which when stacked together form the bipolar battery. In the honeycomb structure the columns are often columnar and hexagonal in shape but may vary as any multi-sided shape dependent on composition and requirements and may include foam structures as an alternative to columnar.

The numbers of cells in the battery determine the voltage and size of plate and corresponding active material and electrolyte quantities determine the amperage.

The fusion of the assembled cell-stack is accomplished using a wire filament embedded in the tongue or the groove of the plate surround which following cell stack assembly is heated sufficiently using a resistive implant process to hermetically seal the cells. In embodiments of the invention this advantageously provides complete cell integrity with absolute sealing and rigidity of the structure.

The cell stack may be assembled into modules which can be connected in parallel or series to provide the required level of amperage or voltage respectively. The modules may be connected by interlocking terminal connections. The interlocking terminals will enable parallel or series connection dependent on alignment with the adjacent module.

Modules will have a current collector plate incorporated into each end plate to efficiently optimise current transfer. The current collector plate may be of a primary and compatible metal including Aluminium, Copper, Zinc, Steel, Brass, Bronze, Titanium or of a composite alloy or biplate of two or more metals or other rigid substances. The purpose of the end plate will be to add rigidity to the end plate in the module.

The current collector plate will be bonded to the metallic surface of the end plate by soldering, conductive adhesion, laser welding, inductive welding or other bonding method appropriate to the materials.

### Example 1

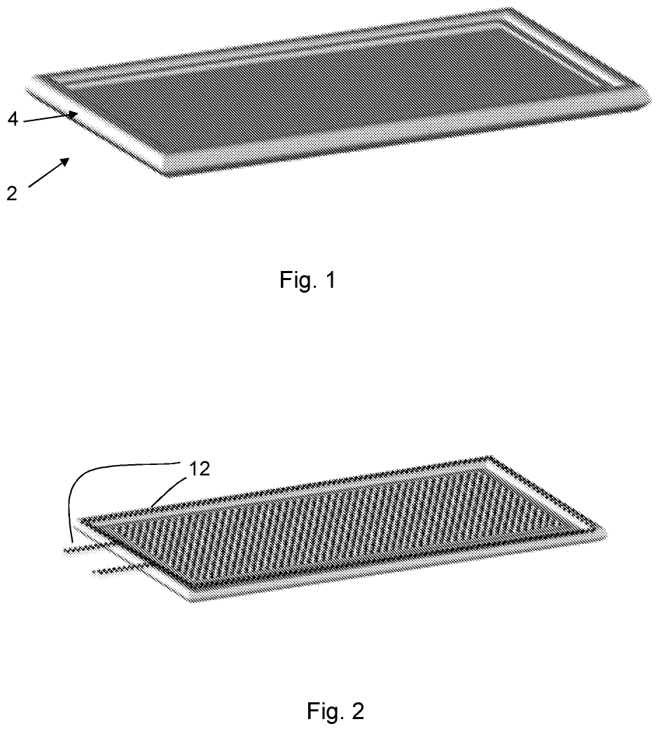

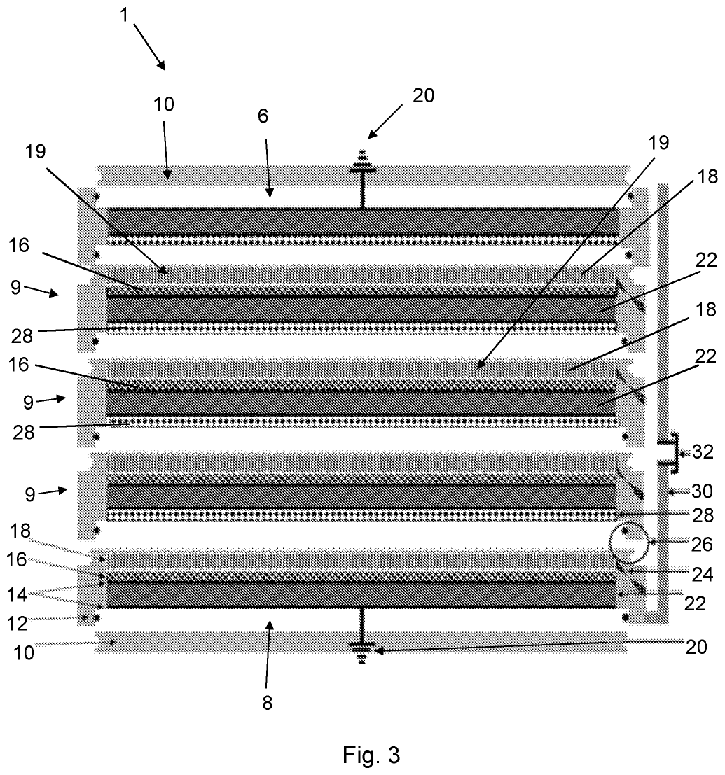

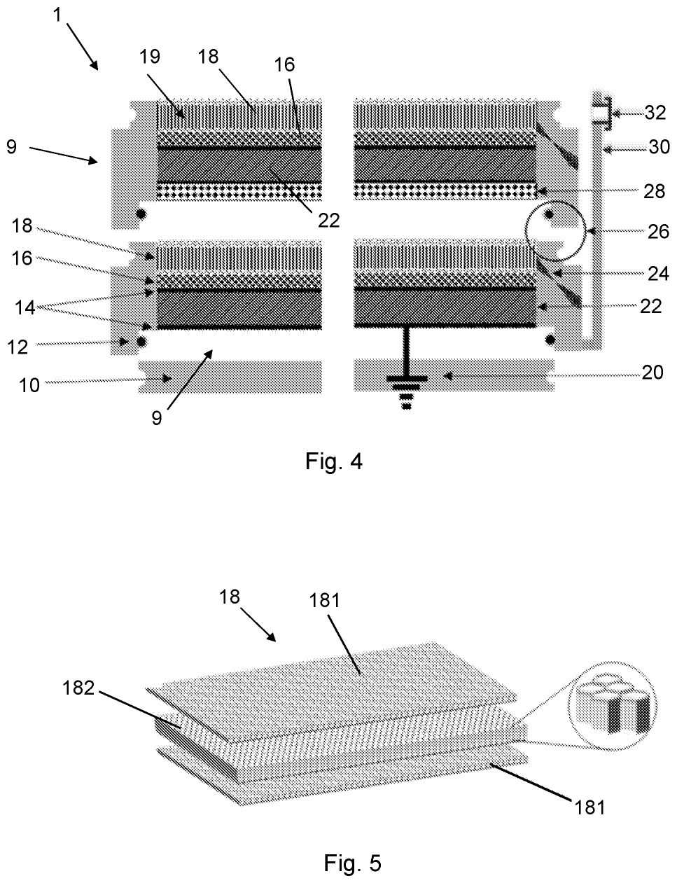

FIGS. 1 to 5 illustrate a specific embodiment of the invention which will now be described in further detail. FIG. 3 is an ‘exploded’ cross section of the cell stack arrangement of a battery 1 according to the embodiment. FIG. 4 is a magnified view of part of FIG. 3. The battery 1 comprises a stack of conductive polymer plates sandwiched between two nonconductive end plates 10, through which are provided the battery terminals 20. At one end of the stack there is a cathode monopolar plate 6 and at the opposite end an anode monopolar plate 8. The plates between the monopolar plates 6, 8 are bipolar plates 9 providing, on opposite sides, an anode and a cathode. The plates 6, 8, 9 are sealed at their perimeters with the use of a tongue & groove mechanical sealing arrangement 26, best seen in FIG. 4. In this example, the surround on the anode side of each bipolar plate has the ‘tongue’ part and the surround on the cathode side of each bipolar plate has the ‘groove’ part.

FIG. 1 shows a metallized polymer plate 2 with a conductive surface and non-conductive surround 4, which is subsequently made into the bipolar plate 9 of the stack. The construction of the bipolar plate requires moulds to be constructed which enable plates to be manufactured in suitable thermo-plastic polymer with a conductive element and a non-conductive edge/surround. In the example of Lead chemistry this is chosen to be ABS. The dimensions of the non-conductive surround will be determined by the size of the battery and thereby the area of the conductive part of the plate and secondly if the cell stack is to act as the external battery casing or if it is to fit inside an additional casing for additional security. Typical width of the non-conductive surround will be in the range of 10 mm to 50 mm. The overall thickness of the non-conductive surround will be in relation to the amount of active materials needed for a given battery specification and size of battery.

One of the features of the conductive bipolar plate according to this embodiment is the ability to form batteries to specific shape requirements, which may be cubic, cylindrical, spherical, conic or other 3D shape to satisfy specific form factor requirements.

The dimensions of the plate are determined by the energy and power capacity requirements of the battery 1 and are of asymmetric depth dimensions to accommodate a AGM/ABS honeycomb 18 (described below) filled with electrolyte during the cell construction process.

In this embodiment, moulded plates are required to exhibit a resistance in the range of 1 m′Ω to 20 m′Ω and preferably <10 m′Ω and more preferably <5 m′Ω across the entire surface to ensure the desired conductivity of the plate. The moulding involves a two-shot process to produce a plate with integrated rim/surround using the same thermoplastic polymer base material. As part of this process an inductive wire element 12 (e.g. either a resistive wire or mesh element) is embedded in the tongue of the non-conductive surround 4 of the plate (as shown in FIG. 2.). This moulding process ensures that the conductive and non-conductive parts of the plates result in an integral plate construction. The diameter of the tongue and groove is in the range of 2 mm to 10 mm depending on the size of the plate and most often in the range 3 mm to 4 mm (as is the case in the present embodiment).

The polymer material of the plate has a conductive core 22 provided by means of conductive filler elements. It may be that a long fibre and ABS pellet melt blending and mixing process is used to achieve a consistent conductivity across the plate as applied in a lead chemistry environment (as described in US 2012/0321836A1 Integral Technologies 2012, the contents of which being incorporated herein by reference).

FIG. 4 shows the provision of a gas pressure release valve 24 incorporated into the non-conductive surround 4 of each cell to provide pressure release during charging in a lead chemistry application. In other chemistries which generate less (or no) gas or vapour during the charging process, this valve mechanism may be omitted. In the present embodiment, a lead chemistry application, the aperture for the addition of the pressure relief valve is accommodated in the cathode side of the non-conductive surround of the asymmetric plate, to allow egress of charging-induced hydrogen and oxygen gasses directly from the electrolyte under controlled conditions with a predetermined pressure setting, between 0.5 psi and 8 psi, or most preferably 1-4 psi to maintain optimal cell pressure.

In chemistries which exhibit gas or vapour as part of the charging process, the cell valves exhaust into a plenum chamber 30 (as shown in FIGS. 3 and 4) to equalize the overall inter-cell pressures. The plenum chamber 30 in turn has a single chamber pressure relief valve 32 to control overall battery gas or vapour pressure. After the two-shot moulding process, the plates require a metallization process involving the application of a metal foil 14, electro-deposited metal or other material which may include one or more trace elements (to the form the metallized polymer plate 2 in the form shown in FIG. 1). The composition of the foils may depend on the chemistry of the battery system and for the Lead bipolar battery 1 of the present embodiment is chosen to be a lead alloy containing appropriate trace amounts of tin, calcium, antimony, or selenium or a mixture of these. In the case of other battery chemistries alternative metals/alloys are used as required by the chemistry with the application of traces of metal or non-metal trace elements.

The metal coating is applied consistently to the conductive plate surface of both the cathode and anode sides of the plate within the confines of the non-conductive surround 4. The thickness of the metallization is determined as part of the energy requirements and dimensions of the plates and is typically 20-1000 microns, preferably 50-500 microns, most preferably 100-250 microns thick.

The application of metallization may be performed using a process of surface laser welding, sonic welding, impulse welding, ultrasonic welding, high frequency welding or other process which consistently attaches the metal surface material across the entire surface forming a strong electrical connection with the conductive element in the bipolar plate forming the electrical connectivity path through the plate, providing consistent and uniform conductivity across the entire plate surface. The surface of the conductive plate may be pre-roughened or ridged/gridded to improve electrical uniformity across the plate, and to ensure better adhesion and conductivity.

The metallized plates require active material to be applied to the cathode surface and in the case of lead chemistry, lead dioxide is applied to the lead cathode plate surface—see the cathode material layers 16 in FIGS. 3 and 4. In the case of other battery chemistries alternative active materials will be used. Similarly anode material (e.g. lead) is deposited on the opposite side of the plate to form an anode layer 28.

The quantity and thickness of the active materials are determined from the plate dimension design in accordance with the overall energy requirements of the cells in ampere hours and quantity of plates determined by desired voltage.

In the case of lead chemistry, the active materials are applied as a paste in a process including the ‘oven curing’ of the materials to ensure adhesion and uniform consistency.

Active material pastes can also include an adhesive plasticizer to prevent cracking during curing, forming and charge/discharge. Active material may also be applied by electro-deposition, spraying, 3-D printing or other accepted method depending on the chemistry, application or plate design.

In the case of lead chemistry, the curing process is typically in the range of 24 hr to 72 hr within a temperature range of 50° C. to 80° C. and generally 50° C. to 55° C.

The electrolyte of the battery 1 used in this example (i.e. lead chemistry) is contained within a composite sandwich 18 formed by outer layers of absorptive glass mat (AGM) 181 and an inner core of electrolyte impervious ABS honeycomb 182, as shown in FIG. 5. The ABS honeycomb has the ability to hold electrolyte whilst allowing the free flow of current, gassing and electrolyte circulation during charge and discharge (although other electrolyte receptacle material composites could be used). Once cured the metallized plates with active materials are individually aligned to accept the AGM/ABS honeycomb sandwich 18. The electrolyte filled composite 18 is placed into a dish 19 formed by the deeper asymmetric dished cathode surface of each plate. The design of this embodiment provides the flexibility to allow active material expansion from the chemical process exhibited during the discharge whilst providing a constraint to possible plate flexing during the valve-controlled pressure build-up. In the case of lead chemistry, the gasses will be Hydrogen and Oxygen during the charge phase.

FIG. 5 shows diagrammatically a cross section of the AGM and ABS-honeycomb sandwich which holds the electrolyte. The thickness of the AGM/honeycomb sandwich is chosen in dependence upon the amount of active materials applied to the bipolar plate surface but will typically be in the range of 1-20 mm, preferably 1-10 mm, more preferably 2-8 mm. The size and thickness of the AGM/ABS honeycomb is also chosen in dependence on the design of the cell and the energy requirement, with the relative thickness of the ABS honeycomb, or other equivalent, being related to the amount of electrolyte required in the cell. The ABS honeycomb may increase rigidity whilst allowing for electrolyte and gas movement. The porosity of the ABS honeycomb and therefore the porosity dimensions will be determined from the electrolyte conductivity and the rigidity required based on the energy and power requirements.

In Lead chemistry the percentage of Sulphuric Acid (H₂SO₄) is in the range 36% to 38% acid to 64% to 62% distilled water, dependent on the desired specification. For other chemistries the electrolyte may comprise of other acids, or non-acid active materials in an aqueous or non-aqueous medium with concentrations of the electrolyte dependent on the given chemistry.

The present embodiment relates to the application of the electrolyte-filled AGM/ABS Honeycomb, where the said assembly is constructed away from the plate with precise quantity and composition of the electrolyte and in the case of lead chemistry this being freeze dried for ease of assembly and prevention of electrolyte contamination of the plate surround. The temperature range for freeze drying in the example of lead chemistry is in the range −50° C. to −70° C. allowing for electrolyte additives to prevent freezing in normal use. Other chemistries using a liquid based electrolyte will adopt different freeze-drying temperatures appropriate to the electrolyte used and any additives. Construction away from the plate and freezing advantageously overcomes the issue of precise electrolyte composition and uniform filling of the cell. It may also help reduce the risk of formation of air pockets in the electrolyte.

As an alternative to using the AGM/ABS structure to hold the electrolyte in the battery, vacuum filling of the cells with the electrolyte may be used. In such a method, each battery cell would be exhausted by vacuum followed by electrolyte injection under pressure of up to 2 kgf/cm 2 through the cell valve locations to enable quick filling of electrolyte. Filling according to this method can be achieved in 60 seconds but cannot achieve maximum electrolyte fill levels. A problem in this filling method lies in that the high pressure is maintained until the end of the filling process, wherein the small voids cannot be filled as the air cannot escape affecting the eventual quality of charge of the battery. However through alternating pulses of vacuum and filling, air can be fully extracted from the cell and total electrolyte saturation achieved.

3-D printing or other accepted deposition may be utilized in the making of the entire battery cell including plate, filament, active materials and ABS honeycomb in which case the electrolyte may also be introduced using the vacuum filling process described above.

In the example of lead chemistry upon assembly the freeze-dried electrolyte/AGM/ABS honeycomb sandwich is placed in the dish 19 formed on to the cathode face of the plate 9. The depth of the dish is chosen to ensure that the said electrolyte sandwich 18 protrudes above the dished rim of the plate as shown in FIGS. 3 and 4. The range of protrusion can be between 1 mm and 3 mm depending on the electrolyte size of cell and chemistry in order to provide the desired degree of compression of the AGM once the stack is compressed.

For the example of lead based chemistry, upon assembly as an individual half-cell, the freeze-dried electrolyte of aqueous diluted H₂SO₄ in the composite sandwich is brought back to ambient temperature through the controlled application of heat, using microwave radiation, infra-red or other reheating process, before being introduced in assembly to a similar half cell with sufficient pressure that the tongue and groove surround uniformly engages around the entire perimeter of the join of the two cells, as shown in FIGS. 3 and 4.

Resistive implant welding is used to hermetically seal the cells, by heating the resistance wire 12 which is embedded in the tongue protrusion inside the perimeter of the plate, as is described below. Heating of the wire may be performed by means of magnetic induction or AC or DC resistive heating.

During final assembly and once the cells are assembled but are under external pressure, heat is generated through a high electric current being passed through the resistance wire or conductive element at a constant temperature. The resistance material heats up due to resistive losses, softening the surrounding plastic. The pressure of the perimeter tongue and groove engagement in the sub-assembly of the cell causes the joint to fuse and on cooling, a weld is formed. The cell stack assembly remains under external pressure until the fused perimeter joints have cooled to ambient temperature creating a hermetic seal.

The welding is at a constant temperature and thermocouples are used to monitor the welding process and to adjust the current and voltage as necessary. The use of a constant temperature process provides greater thermal uniformity.

Metal resistive wire implants or conductive plastic element used for the battery plates will vary according to the composition of the plastic used, and where wire is used this will include copper, tungsten, lead or nickel filaments with diameters ranging between 0.2 mm and 5 mm dependent on the size of the plate. In some instances, multiple wire filaments or mesh implants will be applied dependent on plate size, geometry and chemistry.

Included in the resistive filament process is the deposition or 3-D printing of conductive plastic to effectively form a filament of conductive plastic in the externally non-conductive surround during the moulding of the plate.

There are several advantages of the welding of the plates as performed with the use of this embodiment, including smoother inner surface and welding zone, the resistance wire or mesh filament is protected against damage and controlled heat transfer during the welding process creates a constant temperature in the entire welding area. There is no thermal damage of the material and creates a void-free weld zone around the entire perimeter of the plate join for total cell integrity. Upon recycling the same process can be used to separate the plates.

Other optional methods of welding of the cells to complete a process of hermetical sealing include sonic welding, and laser welding, and depending on the chemistry, size of plates and other factors may influence the method of cell closure and sealing.

The battery 1 assembly process starts with a bottom metallized plate 8 of dished design accommodating the active material and electrolyte/AGM/ABS honeycomb sandwich or other equivalent material on the anode face and only metallization on the reverse face of the plate (i.e. a monopolar plate not having a cathode side).

To this bottom plate 8, completed half-cell assemblies are added with the plates in the horizontal plane with each securely joined to the other through the tongue and groove feature to form a cell stack, which ensures complete integrity of the assembly construction. In each plate 9 that is added to the stack, the dish 19 ensures that the electrolyte is held in place prior to joining of the plate to its neighbour. The desired voltage determines the number of plates, with the final active plate being the top plate 6 (a cathode monopolar plate). The cathode monopolar plate 6 comprises a metallized plate with welded foil on the upper face, which includes the electrode contact for the terminal 20, and the cathode coating 16 of active material to the lower face, as shown in FIG. 3.

Under pressure the top plate assembly which comprises end plates 10 is joined to the uppermost intermediate plate, which is the top cathode monopolar plate 6, in the horizontally positioned assembly of cells with the tongue and groove mechanism ensuring the cell stack is sealed in a primary assembly process before the resistive implant welding of the plate joints. The present embodiment ensures a consistently high level of sealing reducing the potential process disruption of prior art resistive implant welding.

Once the battery cell stack is assembled this is tested to ensure conformity of conductivity before the resistive implant welding is completed and the battery 1 enters a process of battery formation. Formation in the process used in the present embodiment uses automated electric power supply which has higher efficiency than a manual process. The benefits of automation include the increased better cell power characteristics, manufacturing productivity, reduction of production costs, and lower consumption of natural resources The automated equipment incorporates a controller of internal circuit switches, in which the current turns on and off in order to maintain the constant output voltage, that is, one obtains a source of steady electric current. These devices are controlled by software that allows choosing electric current values and application times more accurately than when used analogue equipment.

The process is conducted with the battery cell stack assembled and under pressure before the resistive induction process takes place to hermetically seal the cells. Formation in the example of lead chemistry can range from 10 hrs to 72 hrs with an initial period at ambient temperature without charge to ensure chemical reaction commencement between electrolyte and active materials. For other chemistries differing formation times may apply.

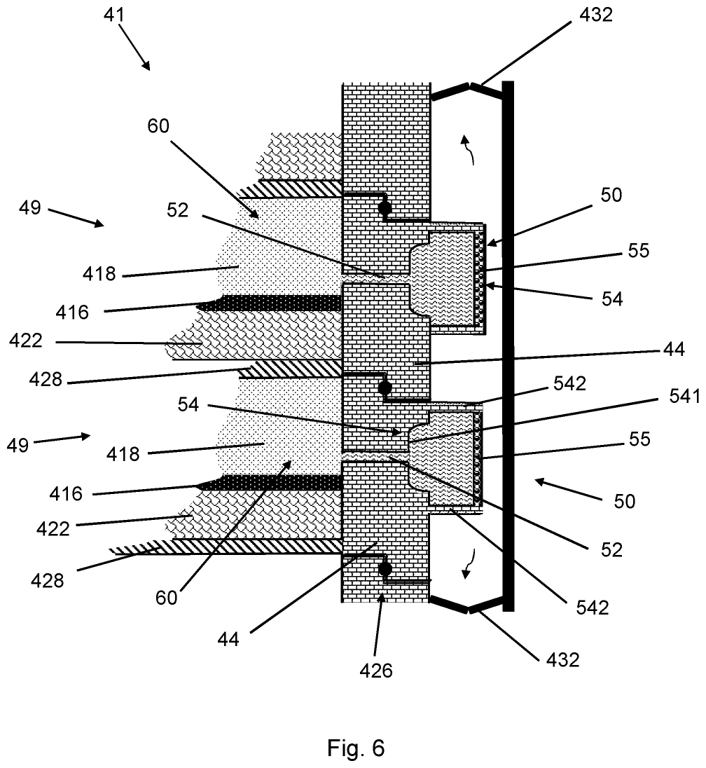

A portion of bipolar battery 41 according to another embodiment of the invention is shown schematically in FIG. 6. The bipolar battery 41 is constructed from a stack of bipolar plates that are similar to the bipolar plates used to form the bipolar battery 1 according to the first embodiment of the invention. Accordingly, where the bipolar battery 41 according to the second embodiment of the invention comprises features present in the bipolar battery 1 according to the first embodiment of the invention, those features have been assigned the same reference numeral, but prefixed with “4”. For example, the bipolar battery 1 according to the first embodiment of the invention comprises plates 9, whereas the bipolar battery 41 according to the second embodiment of the invention comprises plates 49.

FIG. 6 shows a stack of two bipolar plates 49, each providing on opposite sides an anode 428 and a cathode 416, with an electrolyte-containing honeycomb layer 418 located therebetween. The bipolar plates 49 each comprise a gas exhaust system 50 formed in their non-conductive surrounds 44. The gas exhaust system 50 comprises a conduit 52 provided in the nonconductive surround 44 that enables fluid communication between the internal electrolyte-containing region 60 of the bipolar plate 49 and an external electrolyte-containing reservoir 54. The conduit 52 has a small internal diameter, in this case approximately 1 millimetre, which is dimensioned to constrict the flow of electrolyte into the reservoir 54 from the electrolyte containing region 60. The reservoir 54 comprises a base 541 formed by a side of the non-conductive surround 44 and opposing walls 542 that project from the side of the non-conductive surround 44. A gas permeable membrane 55 is provided between the walls 542 of the reservoir 54 to retain the electrolyte within the reservoir 54 whilst permitting gas emissions produced during charging of the battery to escape into a plenum chamber 430. As can be seen, the gas exhaust systems 50 of both of the plates 49 shown in FIG. 5 exhaust gas into the plenum chamber 430 so that the pressures inside the electrolyte-containing regions 60 of the plates 49 equalize. The plenum chamber is provided with at least one pressure release valve 432 to ensure that the plenum chamber 430 does not over pressurise. There may be fewer pressure relief valves than there are bipolar plates. In FIG. 6, two pressure relief valves are shown.

### Example 2

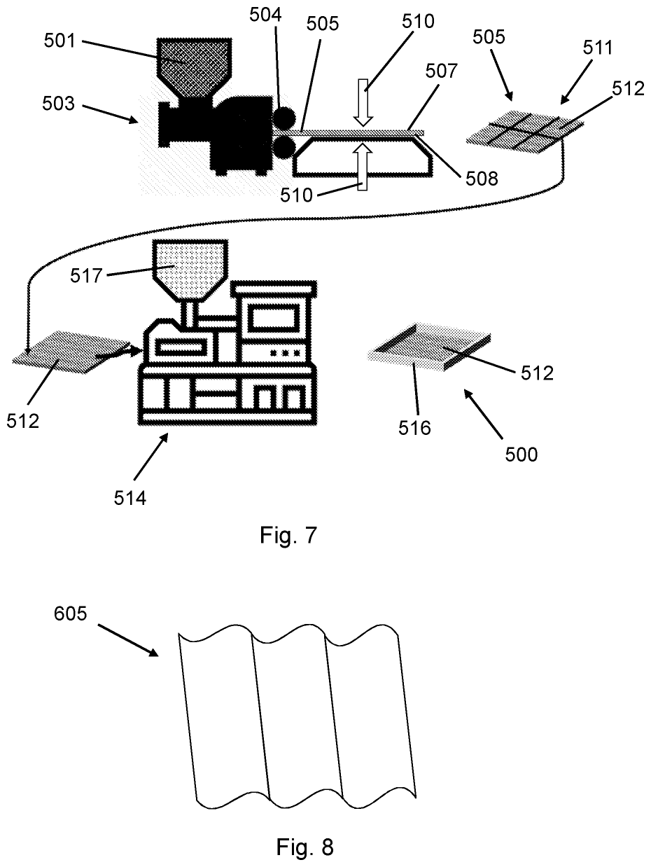

A method of manufacturing bipolar plates 500 for use in a bipolar battery according to an embodiment of the invention will now be described with reference to FIG. 7. A mixture 501 of ABS pellets and tin-coated carbon fibres are put into an extruder 503 and extruded to form a conductive polymer plate 505 having a thickness of approximately 1 millimetre. The thickness of the conductive polymer plate 505 is controlled via calendaring rollers 504 of the extruder 503. In some embodiments, the extruder may comprise a cooling system for cooling the plate. As the conductive polymer plate 505 leaves the extruder 503, both opposing surfaces 507, 508 of the conductive polymer plate 505 undergo a laser-etching treatment 510. The step of laser-etching removes approximately 5 micrometres of the outer surface layer of conductive polymer plate 505 to ensure that tin-coated carbon fibres are exposed on the surface of the conductive polymer plate 505.

In some embodiments of the invention, the extruder 503 may be configured to extrude a corrugated conductive polymer plate 605, such as that shown schematically in FIG. 8, so that the conductive polymer cores of the bipolar plates are corrugated. Corrugated conductive polymer cores not only provide increased surface area but can also provide increased stiffness to the bipolar plate.

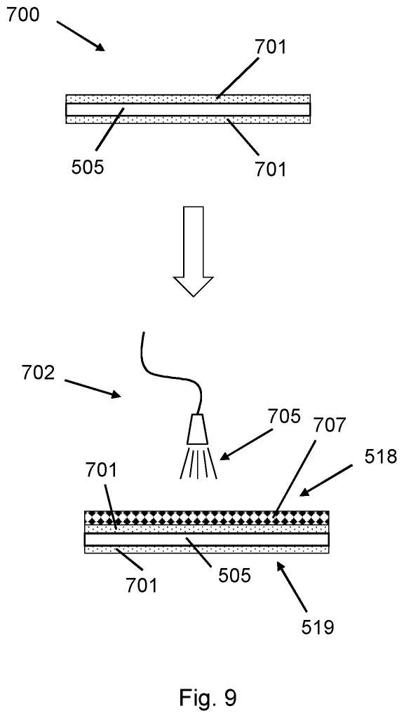

The conductive polymer plate 505 then undergoes a metallization process illustrated in FIG. 9. The conductive polymer plate 505 firstly undergoes an electroplating process 700 to provide an electroplated layer of lead 701 having a thickness of approximately 30 micrometres on both sides of the conductive polymer plate 505.

In this case, the cathode side 518 of the conductive polymer core requires a thicker metallized layer than the anode side 519, so the thickness of the metal layer on the cathode side 518 is increased using a cold spraying process 702. A pressurised a jet of gas and lead/lead alloy powder 705 is fired through a nozzle to deposit a cold-sprayed layer 707 of lead/lead alloy having a thickness of 120 micrometres upon the electroplated layer of lead 701 on the cathode side 518 of the conductive polymer plate 505. This provides a metalized layer having a total thickness of 150 micrometres on the cathode side 518 of the conductive polymer plate 505.

The metalized conductive polymer plate 505 is then cut 511 into individual conductive polymer cores 512 having dimensions of approximately 300×300 using a guillotine.

The conductive polymer cores 512 are then fed into an injection moulding machine 514 where the conductive polymer cores 512 are overmoulded to provide the conductive polymer cores 512 with injection moulded non-conductive polymer surrounds 516 made of pure ABS. In other embodiments of the invention, other polymers may be used and/or the polymer may contain additives such as fire retardant, filler and non-conductive reinforcing fibers 517. This manufacturing technique therefore provides an alternative to the method of producing co-moulded conductive polymer cores and integrally formed non-conductive polymer surrounds.

Further embodiments of the invention are described with the use of the following ordered clauses:

Clause A. A mass producible bipolar battery which can be used in multiple chemistries and any 3D form factor utilising plates of conductive polymer material with similar thermoplastic composition non-conductive surround formed into a series of hermetically sealed cells; eliminating the traditional problems associated with bipolar battery architecture. A metallized surface is provided to the obverse and reverse surfaces of the conductive plates with active material bonded to the metallized surfaces creating an anode to the obverse and cathode to the reverse, with electrolyte solution contained within each cell. Optionally, this is sandwiched between the active materials sealed through interlocking tongue and groove arrangement at the perimeter of the plates to create the said cell, and these arranged in multiple layers to form a battery stack. Optionally, additionally, pressure release valves incorporated into single upwardly positioned apertures in non-conductive rim adjacent to the cathode side of each plate. Optionally, the monopolar endplates comprise of identical conductive polymer plates with non-conductive surround, metallized but with active anode material to one end plate and active cathode to the other end plate. Optionally, both monopolar terminal plates incorporate non-conductive end plates with incorporated terminals, with this arrangement in total being encased in a rigid polymer battery casing.

Clause B. An article according to clause A wherein the bipolar and monopolar plates are constructed using any of determined a range of polymers which are resistant to a given electrolyte and tolerant of cell operating temperature including that these polymers are configured using a given electrically conductive filament mixed within the conductive plate so as to provide uniform conductivity through the plate at any point in its conductive surface.

Clause C. An article according to clause B whereby the polymer and conductive element can be made of a range of thermoplastic polymers with differing temperature and electrolyte anti-corrosion characteristic and a selection of conductive filaments enabling the technology to be applied to any battery chemistry.

Clause D. An article according to any preceding Clause wherein the bipolar and monopolar plates are moulded in a two-shot process using a given polymer with conductive elements and the same polymer without the conductive element ensuring the plate has a non-conductive surround which is integral to the given plate.

Clause E. An article as an alternative to the preceding Clause wherein the bipolar and monopolar plates are moulded through an extrusion process and the non-conductive surround added as a separate over-moulding process Clause F. An article according to any of Clauses A to C whereby the bipolar and monopolar plates are constructed by 3-D printing of the conductive filament and the subsequent flooding of the said filament with melted thermoplastic polymers to achieve the correct depth and alignment to ensure plate conductivity to the desired level. To this is optionally added the surround in the similar thermoplastic polymer to complete the monopolar or bipolar plate dimensions.

Clause G. An article according to clauses D and E where the surround forming the non-conductive surround to each plate when assembled into a cell stack becomes the external battery case when the bipolar and monopolar plates are fused through resistive implant welding.

Clause H. An article according to any preceding Clause wherein the bipolar and monopolar plates are metallized with any metallic substance which may be pure or contain trace elements or be an alloy, and the metallization process comprises of any form of welding which melts the polymer surface of the conductive aspect of the plate thereby exposing the conductive element and creating a uniform electronic fusing between the conductive element and the metallization material, this being applied to the obverse and reverse of each bipolar and monopolar plate uniformly.

Clause I. An article according to clause D and E wherein the nonconductive surround to each bipolar plate is moulded with a tongue and groove arrangement whereby each plate has a perimeter tongue on the anode side of the plate with a corresponding perimeter groove on the cathode side of the plate in order that the pressure assembled cells fit securely together without leakage. Optionally, the monopolar plates have a tongue arrangement to the bottom assembly plate to both upper and lower rims of the plate and the upper assembly monopolar plate has the 3 mm tongue arrangement to the upper rim and 3 mm groove to lower rim. Optionally, the diameter of the tongue and groove is in the range of 2 mm to 10 mm dependent on the overall plate design, but ideally in the range 3 mm to 4 mm.

Clause J. An article according to clause I wherein the tongue in each bipolar and monopolar plate has an electric wire or conductive mesh element embedded into it for the entire circumference with external electrodes enabling the wire element to be heated for circa 5 seconds to 20 seconds once the tongue and groove is fully engaged during assembly thereby resistive implant welding the tongue and groove joint completely around the entire perimeter join of each cell interface. Optionally, the heating time is dependent on the diameter of the tongue and the overall perimeter dimensions of the plate.

Clause K. An article according to any preceding Clause wherein the assembled cell stack has incorporated rigid thermoplastic polymer end plates (e.g. see FIG. 4 items 10) to prevent distortion of the monopolar plates from gas or vapour emission during the charge process, with the end plates having a perimeter groove moulded to the entire circumference enabling secure assembly and resistive implant welding of the perimeter joint. Optionally, the thickness of the end plates is in the range 10 mm to 50 mm dependent on battery dimensions.

Clause L. An article according to clause J wherein the rigid polymer endplates are constructed to allow through the plate electrical connection of the terminal to the adjacent monopolar plate (e.g. see the terminal of FIG. 4 labelled as item 20) and that this connection is of conductive polymer.

Clause M. An article according to any preceding Clause wherein the electrolyte is contained in a composite sandwich of active glass matting (AGM) and a core of Polymer honeycomb (e.g. see FIG. 4, item 18). Optionally, in the example of lead chemistry ABS polymer is used for the honeycomb. Optionally, the thickness of this composite is dependent on electrolyte volume and same polymer material as the plates thereby providing a restraint to plate distortion during hydrogen and oxygen gas issue as part of the charging process, with the honeycomb pore dimensions of between 100 and 2000 microns, preferably 300-1500 microns, more preferably 500-1000 microns—e.g. dependent on electrolyte viscosity.

Clause N. An article according to clause M wherein the composite sandwich of AGM and ABS honeycomb is saturated with a quantity of electrolyte at a given concentration and this is freeze dried to a temperature below the freezing point of the electrolyte as a process to handle the assembly of the cells without contamination of the plate surrounds and once assembled into the plate returned to ambient temperature through infra-red or microwave re-heating.

Clause O. An article according to clause M wherein the composite sandwich of AGM and ABS honeycomb is saturated with a quantity of electrolyte at a given concentration through a method of pulse vacuum filling whereby electrolyte is drawn into the cell through a non-return aperture and air extracted through the same aperture by vacuum using an alternating vacuum pulse.

Clause P. An article according to any preceding Clause in which a bipolar battery is encased in a larger container, enabling the battery to fit the space of a larger battery which it replaces. Optionally, the said container construction would be of thermoplastic polymer, metal or other material determined by the battery size, shape or chemistry and this container include terminal fittings, wiring and securement housings for fitment to a mounting, with the option to be sealed.

Clause Q. An article comprising:
a) the construction of a bipolar battery cell stack of one or multiple plates moulded from an electrolyte inert electrically conductive polymer which incorporates a nonconductive plate surround where the conductive area of each plate is metallized and coated with active material to each electrolyte facing plane;
b) each monopolar and bipolar plate has a perimeter tongue and groove design for the plates to be securely joined;
c) the perimeter tongue of each plate has imbedded a metal filament through the entire perimeter so that the assembled tongue and grove join can be resistive implant welded to provide a robust seal;
d) between each plate is situated a composite of AGM and polymer honeycomb to hold the electrolyte whilst maintaining cell rigidity; and
e) nonconductive end plates are resistive implant welded to the monopolar terminal plates to provide end plate rigidity.

It will of course be appreciated that features described in relation to one embodiment (or above clause) of the present invention may be incorporated into other aspects of the present invention.

Whilst the present invention has been described and illustrated with reference to particular embodiments, it will be appreciated by those of ordinary skill in the art that the invention lends itself to many different variations not specifically illustrated herein.

Metallization of the polymer plates before adding the active (anode or cathode) material may not be necessary, particularly with regards to the anode which may comprised mostly lead in any case.

Where in the foregoing description, integers or elements are mentioned which have known, obvious or foreseeable equivalents, then such equivalents are herein incorporated as if individually set forth. Reference should be made to the clauses for determining the true scope of the present invention, which should be construed so as to encompass any such equivalents. It will also be appreciated by the reader that integers or features of the invention that are described as preferable, advantageous, convenient or the like are optional and do not limit the scope of the independent clauses. Moreover, it is to be understood that such optional integers or features, whilst of possible benefit in some embodiments of the invention, may not be desirable, and may therefore be absent, in other embodiments.

1. A method of manufacturing a plate suitable for use as a bipolar plate in a bipolar battery, wherein the method comprises the steps of:
extruding a first polymer containing conductive particles to form a conductive polymer plate,
cutting a conductive polymer core for the plate from the conductive polymer plate, and
overmoulding the conductive polymer core with a second polymer to provide the conductive polymer core with a non-conductive polymer surround that has a thickness which is greater than the thickness of the conductive polymer core.

2. The method of claim 1, wherein at least one of the surfaces of the conductive polymer plate is abraded to expose the conductive particles prior to the step of cutting the conductive polymer core for the bipolar plate from the conductive polymer plate.

3. The method of claim 2, wherein the step of abrading comprises abrading the at least one surface of the conductive polymer plate as the conductive polymer plate leaves the extruder.

4. The method of claim 2, wherein the step of abrading comprises laser etching the at least one surface of the conductive polymer plate.

5. The method of claim 1, wherein the conductive polymer core is cooled to room temperature before the step of overmoulding.

6. The method of claim 1, wherein the extruded conductive polymer plate is corrugated.

7. The method of claim 1, wherein the method comprises the step of providing a first metallic layer of a first thickness on a first side of conductive polymer plate and providing a second metallic layer of a second, greater thickness on a second side of the conductive polymer plate.

8. The method of claim 7, wherein at least part of the first metallic layer or at least part of the second metallic layer are formed by electroplating onto the surface of the conductive polymer plate.

9. The method of claim 7, wherein at least part of the first metallic layer or at least part of the second metallic layer are formed by cold spraying.

10. The method of claim 7, wherein a first part of the second metallic layer is formed by electroplating onto the surface of the conductive polymer plate and a second part of the second metallic layer is formed by cold spraying onto the electroplated first part.

11. The method of claim 10, wherein at least part of the first metallic layer is formed by electroplating onto the surface of the conductive polymer plate, and the at least first part of the first metallic layer has a thickness that is equal to the thickness of the first part of the second metallic layer.

12. A method of manufacturing a bipolar battery comprising
manufacturing a plurality of plates according to claim 1,
forming a stack from the plurality of plates and sandwiching the plates between two monopolar plates,
wherein the stack is formed by
placing electrolyte material into a dish formed by a first plate, the dish comprising a base provided by a metallic layer of the first plate and sides defined by the non-conductive surround of the first plate,
engaging the non-conductive surround of the first plate with the non-conductive surround of a second plate such that a metallic layer of the second plate and the dish of the first plate define a chamber which contains the electrolyte material, the electrolyte material thereby being positioned between
an anode layer of one of the first and second plates and an opposing cathode layer of the other of the first and second plates.

13. A method of manufacturing plate suitable for use as a bipolar plate in a bipolar battery, wherein the method comprises the steps of:
providing a conductive polymer plate for forming a conductive polymer core of a bipolar plate,
cold spraying at least one side of the conductive polymer plate to provide a metallic layer on the at least one side of conductive polymer plate.

14. (canceled)

15. A bipolar battery comprising a stack of multiple bipolar plates sandwiched between two monopolar plates, wherein
the bipolar plates each comprise an extruded conductive polymer core thus having a substantially constant cross-section, the core being moulded to a non-conductive polymer surround, there being a layer of anode material on one side of the bipolar plate and a layer of cathode material on the opposite side of the bipolar plate,
the battery comprises a casing, the layers of anode material and cathode material being contained within the casing,
the casing is formed at least in part by the non-conductive polymer surrounds of all of the bipolar plates.

16. Tag bipolar battery according to claim 15, wherein the constant cross section of the extruded conductive polymer core comprises one or more sections of different thickness.

17. The bipolar battery according to claim 15, wherein the constant cross-section of the extruded conductive polymer core comprises one or more sections of different height.
